(19) United States
(12) Patent Application Publication
(10) Pub. No.: US 2006/0272165 A1
(43) Pub. Date: Dec. 7, 2006

(54) Systems and methods for creating precise notches in a medium

(76) Inventor: Rachel Brenchley, Kaysville, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/435,275

(22) Filed: May 15, 2006

Related U.S. Application Data
(60) Provisional application No. 60/680,897, filed on May 13, 2005.

(51) Int. Cl. B26F 1/00

(52) U.S. Cl. 30/358; 30/315

(57) ABSTRACT

Systems and methods for creating precise notches in a medium. A notch creating tool includes a handle and a blade, wherein the blade is in a desired configuration to enable a user of the tool to create precise notches in a medium. The blade is positioned on a desired location of the medium with the cutting edge down. A force is provided on the tool, such as by rocking the tool, pressing on the handle and/or tapping the handle with a hammer. The force on the tool allows the blade to create a precise notch in the medium, wherein the notch reflects the shape of the blade configuration.

### RELATED APPLICATIONS

This application claims priority to U.S. Provisional Patent Application Ser. No. 60/680,897 filed May 13, 2005, entitled SYSTEMS AND METHODS FOR CREATING PRECISE NOTCHES IN A MEDIUM, which is incorporated herein by reference.

### BACKGROUND OF THE INVENTION

1. Field of the Invention

The present invention relates to cutting a medium. In particular, the present invention relates to systems and methods for creating precise notches in a medium.

2. Background and Related Art

Techniques are currently available for use in the scrapbooking industry for punching out shapes in paper. Such available techniques include the use of die cuts, which are desired shapes that are punched out of paper, such as near the edge of the paper, and used as part of a decorative design in creating a scrapbooking page.

While techniques currently exist that are used to punch out shapes from paper, challenges still exist, including limiting the user to the particular punch out shape designs. Accordingly, it would be an improvement in the art to augment or even replace current techniques with other techniques.

### SUMMARY OF THE INVENTION

The present invention relates to cutting a medium. In particular, the present invention relates to systems and methods for creating precise notches in a medium.

Implementation of the present invention includes a tool having a handle and a blade. The blade is in a desired configuration to enable a user of the tool to create precise notches in a medium. Examples of such media include paper, cardstock, material, plastic, or the like.

In a particular implementation, the tool includes a handle having a hollow base receiving portion. Individual base units are selectively coupled to the base receiving portion, wherein each base unit includes a blade having a different configuration. Accordingly, a user can selectively create different notches by interchanging base units to the handle. A base unit may be coupled to the base receiving portion through the use of a magnet, a screw, a latch, or other coupling mechanism.

Representative use of a precise notch creating tool system includes placing a self-healing craft mat under a particular medium to cut. The base unit having the desired blade configuration is selected and inserted into and coupled to the base receiving portion of the handle. The blade is positioned on a desired location of the medium with the cutting edge down. A force is provided on the tool, such as by rocking the tool, pressing on the handle or tapping the handle with a hammer. The force on the tool allows the blade to create a precise notch in the medium, wherein the notch reflects the shape of the blade configuration.

While the methods and processes of the present invention have proven to be particularly useful in the area of scrapbooking, those skilled in the art can appreciate that the methods and processes can be used in a variety of different applications and in a variety of different manners to yield the creation of precise notches in a medium. Examples of such applications embrace crafting, stationary, cards, custom announcements, invitations, graphic designs, and other applications.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of a first end of a representative notch creating tool system in accordance with an embodiment of the present invention;

FIG. 2 illustrates a perspective view of a second end of the representative notch creating tool system of FIG. 1;

FIG. 3 illustrates a side view of the notch creating tool system of FIG. 1;

FIGS. 4A-4B illustrate a representative notch creating tool system in accordance with an embodiment of the present invention, wherein the interchangeable base unit and handle are selectively coupled or separated;

FIGS. 5A-5B illustrate a cross sectional view of the notch creating tool system of FIGS. 4A-4B, wherein the interchangeable base unit and handle are selectively coupled or separated;

FIG. 6A illustrates an exploded view of a notch creating tool system having an interchangeable base unit in accordance with a representative embodiment of the present invention;

FIG. 6B illustrates an end view of the interchangeable base unit of the embodiment of FIG. 6A, wherein the interchangeable base unit includes a blade having a first configuration;

FIG. 6C illustrates a side view of the notch creating tool system of FIG. 6A;

FIG. 7A illustrates an exploded view of a notch creating tool system having an interchangeable base unit in accordance with a representative embodiment of the present invention;

FIG. 7B illustrates an end view of the interchangeable base unit of the embodiment of FIG. 7A, wherein the interchangeable base unit includes a blade having a second configuration;

FIG. 7C illustrates a side view of the notch creating tool system of FIG. 7A;

FIG. 8A illustrates an exploded view of a notch creating tool system having an interchangeable base unit in accordance with a representative embodiment of the present invention;

FIG. 8B illustrates an end view of the interchangeable base unit of the embodiment of FIG. 8A, wherein the interchangeable base unit includes a blade having a third configuration;

FIG. 8C illustrates a side view of the notch creating tool system of FIG. 8A;

FIG. 9 illustrates an exploded view of a notch creating tool system having interchangeable base units in accordance with a representative embodiment of the present invention;

FIG. 10 illustrates a side view of the notch creating tool system of FIG. 9;

FIG. 11 illustrates a representative use of a notch creating tool system of the present invention that enables attachment of a name plate, business card, tag, or the like to a particular medium without use of an adhesive;

FIG. 12 illustrates a representative use of a notch creating tool system of the present invention that enables creation of closure options without the use of an adhesive;

FIG. 13 illustrates a representative use of a notch creating tool system of the present invention that enables the cutting of configurations from the edges of a medium in order to create finger grips; and

FIG. 14 illustrates representative use of a notch creating tool system of the present invention that enables creation of notches for laces and/or weaving.

### DETAILED DESCRIPTION OF THE INVENTION

The present invention relates to cutting a medium. In particular, the present invention relates to systems and methods for creating precise notches in a medium.

Embodiments of the present invention embrace a notch creating tool system configured to cut precise notches in any particular medium (e.g., paper, cardstock, material, polymer, etc.), wherein the notch creating tool system includes a handle and a blade. The blade is in a desired configuration and is open-ended to enable a user of the tool to create precise notches in a medium that reflect the blade configuration.

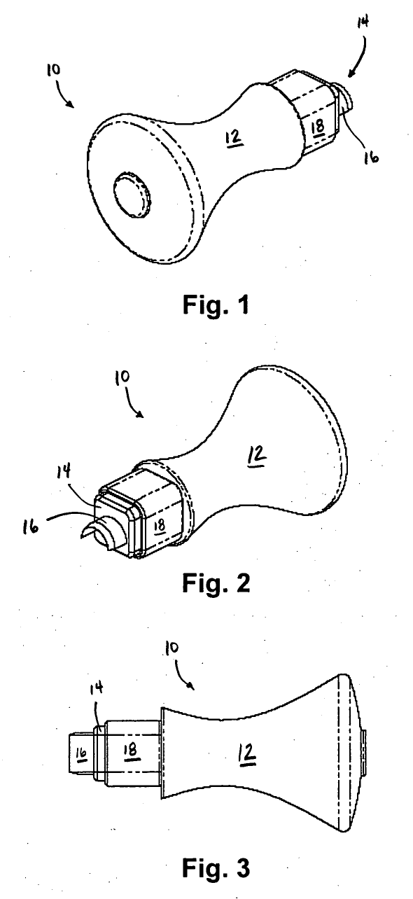

FIGS. 1-10 illustrate a representative notch creating tool system in accordance with a representative embodiment of the present invention. With reference to FIGS. 1-2, a perspective view of a representative notch creating tool system 10 is illustrated. Notch creating tool system 10 includes handle 12 and base unit 14, wherein base unit 14 includes blade 16 and is selectively received by handle 12 at base receiving portion 18.

In accordance with the present embodiment, individual base units are selectively coupled to the handle to allow the user to create different types of notches. Each base unit includes a different blade configuration. Examples of such blade configurations include an arch, a line, a wave, an acute angle, an obtuse angle, a right angle, or other blade configuration. Accordingly, a user can selectively create different notches by interchanging base units to the handle. In some embodiments, a base unit is coupled to the base receiving portion through the use of a magnet, a screw, a latch, or other coupling mechanism. In other embodiments, the base units are fixed rather than being interchangeable.

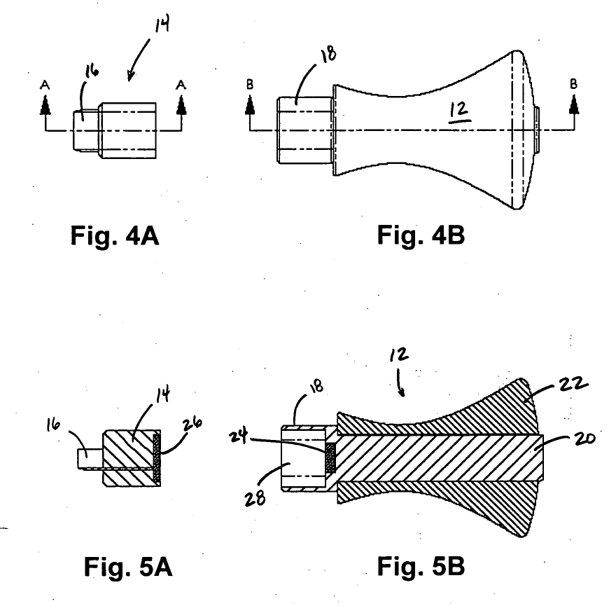

With reference to FIGS. 3-4B, illustrations are provided relating to a representative embodiment wherein a handle and base unit of a notch creating tool system are selectively coupled (see FIG. 3) or detached (see FIGS. 4A-4B). In FIG. 3, the handle and base unit are coupled for use in creating a precise notch in a medium. When coupled, the blade of the base unit may be placed in the exact location of the medium where the user desires to create a notch that reflects the blade configuration. A force is place on the blade, causing the blade to cut into the medium and create the precise notch. Such method of use of the notch creating system will be further discussed below.

In the current embodiment, the blade 16 is coupled to a square base unit that is removably coupled to the handle 12. FIGS. 4A-4B illustrate the separation or decoupling of the base unit 14 (FIG. 4A) from the handle 12 (FIG. 4B) to enable the user to interchange base units and thus create different types of notches.

FIGS. 5A-5B respectively illustrate a cross sectional view of the notch creating tool system of FIGS. 4A-4B, wherein the handle and interchangeable base unit are separated. For FIG. 5A, the cross sectional view is made at A-A (FIG. 4A). For FIG. 5B, the cross sectional view is made at B-B (FIG. 4B). In FIG. 5B, handle 12 comprises a metal shaft 20 and optionally a wood or plastic handle portion 22. The metal shaft 20 provides increased strength to the notch creating system, and allows the user to utilize a hammer or other force producing tool to produce a force on handle 12 by tapping on metal shaft 20.

In the illustrated embodiment, base receiving portion 18 comprises a magnet 24, which selectively couples base unit 14 at metallic surface 26 to base receiving portion 18 through a magnetic force. Thus, base unit 14 is received in cavity 28 of base receiving portion 18.

In the illustrated embodiment, blade 16 is coupled to metallic surface 26, thus allowing an interconnected metallic system, when coupled, to extend from an end of handle 12 to blade 16. Specifically, the interconnected metallic system includes metal shaft 20, which is coupled to base receiving portion 18, which receives and is coupled to metallic surface 26, which is coupled to blade 16.

Those skilled in the art will appreciate that other embodiments of the present invention include a notch creating tool that includes a base receiving portion that is adjustable to various sizes of base units, a notch creating tool that has a fixed base unit, a notch creating tool system that comprises a transparent material to allow the used to look through at least a portion of the tool to precisely locate the blade, and other such notch creating tools.

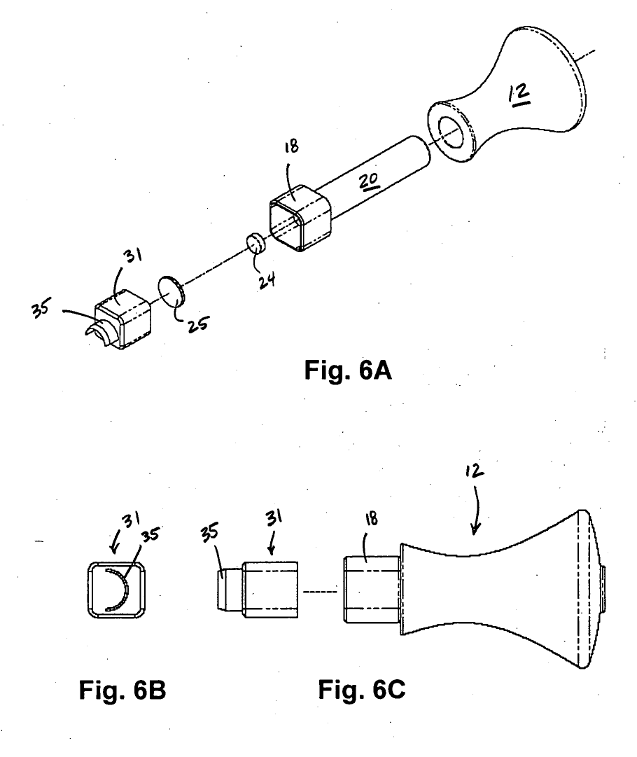

With reference now to FIG. 6A, an exploded view of notch creating tool system 10 is illustrated, wherein the system includes base unit 31. As illustrated, notch creating tool system 10 includes handle 12, metal shaft 20, base receiving portion 18, magnet 24, metallic surface 25, base unit 31 and blade 35. In at least some embodiments, handle 14 is selectively interchangeable with other handles that are configured to couple to shaft 20. Moreover, in at least some embodiments, any portion of the notch creating tool system is interchangeable.

FIG. 6B illustrates an end view of base unit 14 of FIG. 6A, wherein base unit 31 includes blade 35 having a blade configuration. FIG. 6C illustrates a side view of the notch creating tool system of FIG. 6A, wherein handle 12 and base unit 31 are decoupled.

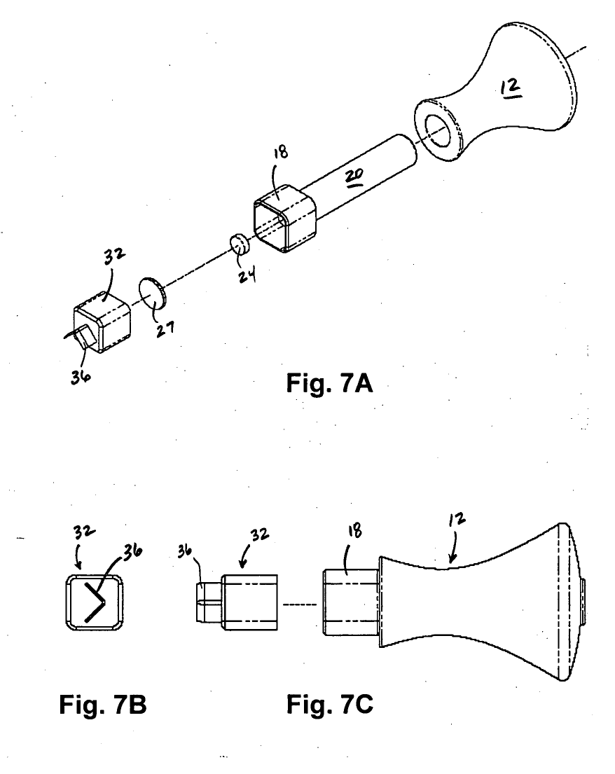

With reference now to FIG. 7A, an exploded view of notch creating tool system 10 is illustrated, wherein the system includes base unit 32. As illustrated, notch creating tool system 10 includes handle 12, metal shaft 20, base receiving portion 18, magnet 24, metallic surface 27, base unit 32 and blade 36.

FIG. 7B illustrates an end view of base unit 34 of FIG. 7A, wherein base unit 32 includes blade 36 having a blade configuration. FIG. 7C illustrates a side view of the notch creating tool system of FIG. 7A, wherein handle 12 and base unit 32 are decoupled.

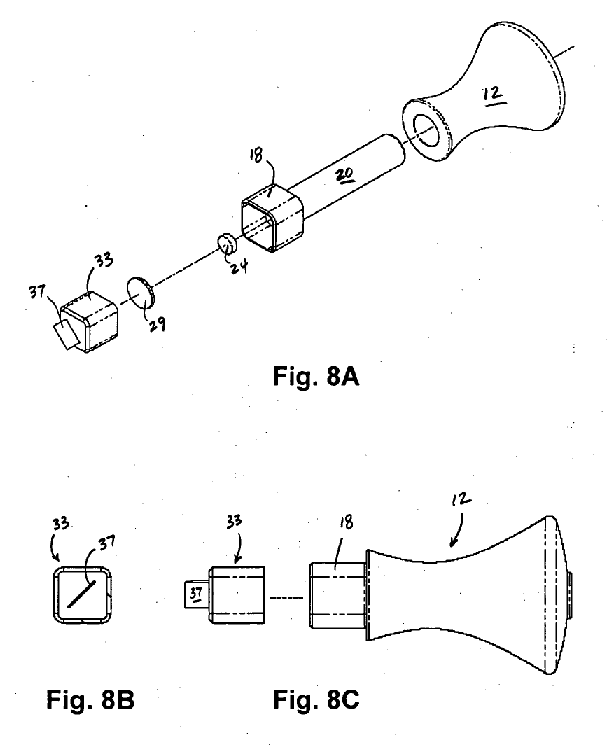

With reference now to FIG. 8A, an exploded view of notch creating tool system 10 is illustrated, wherein the system includes base unit 33. As illustrated, notch creating tool system 10 includes handle 12, metal shaft 20, base receiving portion 18, magnet 24, metallic surface 29, base unit 33 and blade 37.

FIG. 8B illustrates an end view of base unit 33 of FIG. 8A, wherein base unit 33 includes blade 37 having a blade configuration. FIG. 7C illustrates a side view of the notch creating tool system of FIG. 7A, wherein handle 12 and base unit 33 are decoupled.

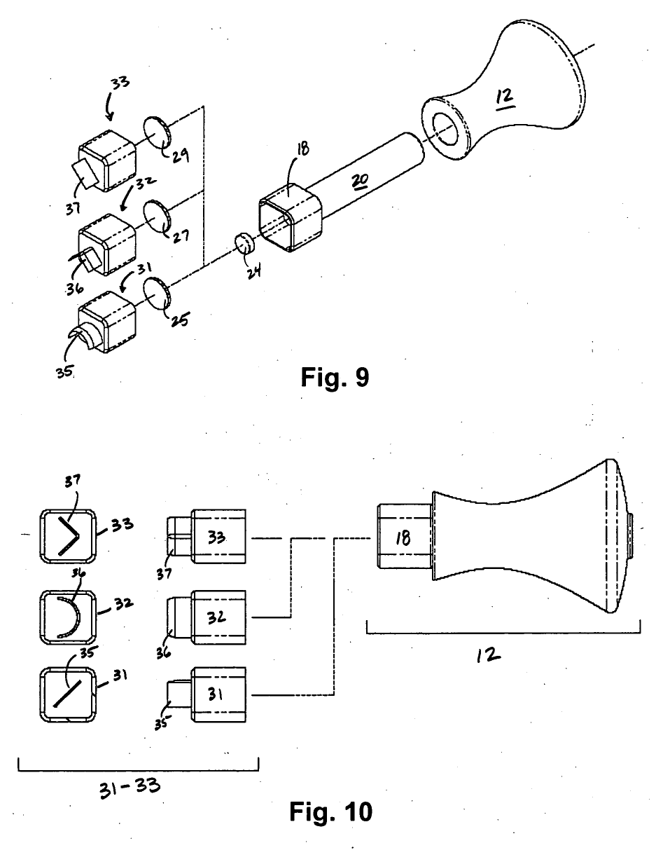

With reference now to FIG. 9, an exploded view of notch creating tool system is illustrated, wherein the system includes interchangeable base units. As illustrated, the notch creating tool system 10 includes handle 12, metal shaft 20, base receiving portion 18, magnet 24, metallic surfaces 30, base units 31-33 and blades 35-37. Handle 14 is selectively interchangeable with other handles that are configured to couple to shaft 20.

While the illustrated base units are generally cubic in shape, other embodiments embrace other shapes of base units. Additionally, FIG. 10 illustrates an end view of the illustrated blades. Those skilled in the art will appreciate that other embodiments of the present invention embrace multiple blades per base unit, other sizes of blades, and other blade configurations.

Representative use of a precise notch creating tool system includes placing a self-healing craft mat under a particular medium to cut. The base unit having the desired blade configuration is selected and inserted into and coupled with the base receiving portion of the handle. The blade is positioned on a desired location of the medium with the cutting edge down. A force is provided on the tool, such as by rocking the tool, pressing on the handle or tapping the handle with a hammer. The force on the tool allows the blade to create a precise notch in the medium, wherein the notch reflects the shape of the blade configuration.

Embodiments of the present invention can be used in a variety of applications such as in crafting, stationary, card making, creating invitations, custom announcements, graphic design, and other such applications. Use of the tool allows the user to create precision notches for slipping name plates, business cards, tags, etc. thereunder to secure them to a medium with out using an adhesive. An example of such use is illustrated in FIG. 11, wherein design work 40 includes a medium 42 that includes one or more precise notches 44 created therein by a blade of a precise notch creating tool of the present invention. Notches 44 receive a business card 46 and couple the business card 46 to the medium 42. Additionally, FIG. 11 illustrates one or more precise notches 48 created in the striped medium to provide additional design to design work 40, and receive and couple medium 42 to the underlying striped medium.

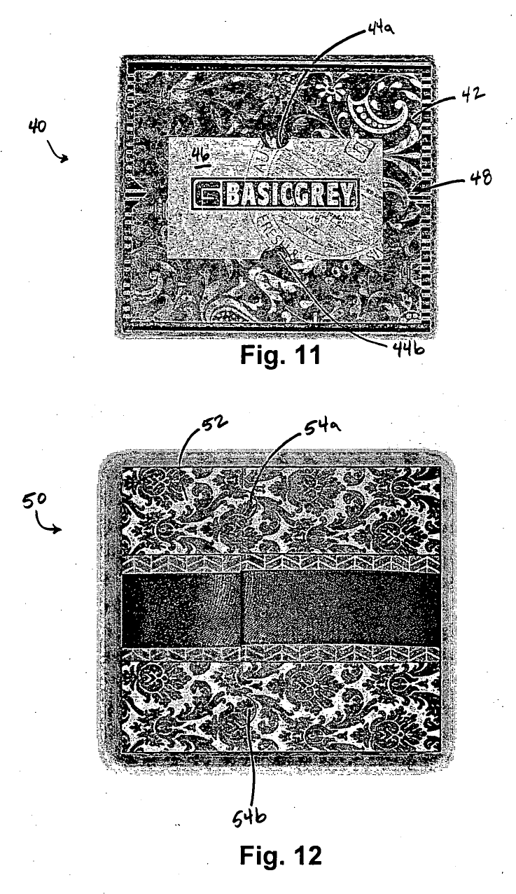

Use of the tool allows the user to create precision notches for creating unique closure options without the use of an adhesive. A representative closure option is illustrated in FIG. 12, wherein design work 50 includes medium 52 having one or more notches 54 created therein for use as a closure, wherein the notches 54 are used to receive an end of the medium. In a further embodiment, a straight edge blade configuration is used to make a slit in one side, and the medium is folded around and insert into a “V” or “U” (e.g., smile) notch to close.

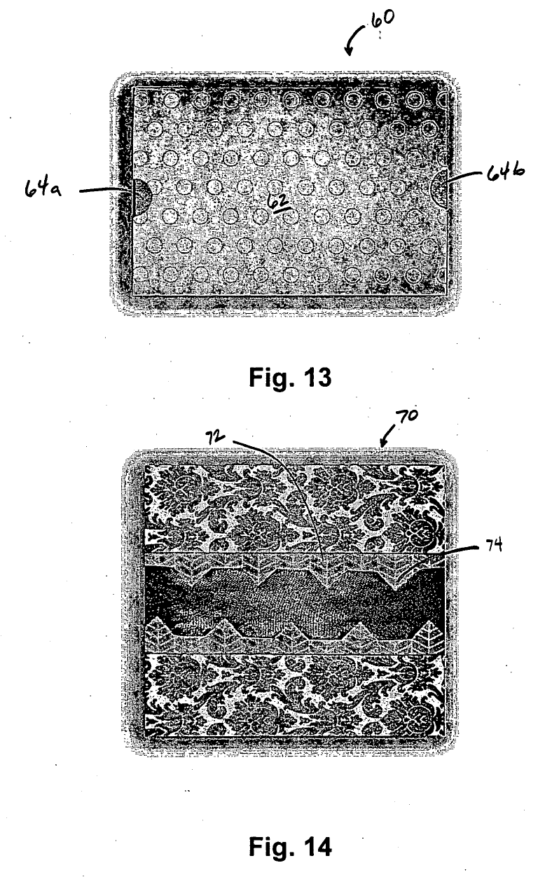

Use of the tool allows a user to create precision notches for cutting half circles or V's from the edges of the medium, making finger grips. FIG. 13 illustrates a representative embodiment, wherein design work 60 includes medium 62 having one or more notches 64 cut therein to form finger grips.

Use of the tool allows the user to create precise, custom notches for lacing or weaving. FIG. 14 illustrates a representative embodiment, wherein design work 70 includes medium 72 having one or more notches 74 cut therein to allow a ribbon or other medium to be threaded or otherwise held by the notches. In a further embodiment, a base unit having multiple blades allows for a medium (e.g., paper, ribbon, etc.) to be threaded through the notches.

Those skilled in the art will appreciate that embodiments of the present invention embrace many other closure and securing options through use of a notch creating tool of the present invention. Embodiments of the present invention embrace an open-ended blade for cutting notches. While punch or die cuts are designed to remove a shape from a page, embodiments of the present invention cuts precise slits (i.e., notch) in a medium for use in securing objects, making unique closures as a design element, and other purposes as discussed herein.

In some embodiments, a base unit includes a closed-ended blade configuration to cut a shape from a page. In a further embodiment, the base unit comprises a closed-ended blade configuration that is interchangeable with other base units having open-ended blade configurations.

In a further embodiment, a notch creating tool of the present invention includes a Japanese screw punch mechanism. Other embodiments include notch creating tools that include a variety of shapes and/or sizes of the open end ruling. In a further embodiment, the handle provides a container or other holding location for the various base units or blade configurations. In a further embodiment, the blade and handle are coupled such that a force is not placed on the end of the handle, but instead onto another surface of the tool to cause the blade to create a precise notch in a medium. In a further embodiment, a tool includes a base unit that is used without a handle to receive a force and create a notch in a medium.

Thus, as discussed herein, the embodiments of the present invention embrace cutting a medium. In particular, the present invention relates to systems and methods for creating precise notches in a medium. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A notch creating apparatus that is configured to receive a force to create a notch in a medium, the apparatus comprising:
a handle;
a base unit removably coupled to the handle; and
a blade having an open-ended blade configuration, wherein the base unit comprises the blade.

2. A notch creating apparatus as recited in claim 1, wherein the handle comprises a metallic shaft.

3. A notch creating apparatus as recited in claim 1, wherein the handle comprises a base receiving portion that is configured to receive the base unit.

4. A notch creating apparatus as recited in claim 3, wherein the base unit comprises a metallic surface, wherein the base receiving portion comprises a magnet, and wherein the handle and the base unit are removably coupled by a magnetic force.

5. A notch creating apparatus as recited in claim 1, wherein the base unit is a first base unit, and wherein the apparatus further comprises:
a second base unit removably coupled to the handle and interchangeable with the first base unit; and
a second blade having an open-ended blade configuration, wherein the second base unit comprises the second blade.

6. A notch creating apparatus as recited in claim 1, wherein the base unit is a first base unit, and wherein the apparatus further comprises:
a second base unit removably coupled to the handle and interchangeable with the first base unit; and
a second blade having a closed-ended blade configuration, wherein the second base unit comprises the second blade

7. A notch creating apparatus as recited in claim 1, wherein the handle is interchangeable.

8. A notch creating apparatus as recited in claim 1, wherein the base unit comprises a Japanese screw punch mechanism.

9. A notch creating apparatus as recited in claim 1, wherein the base unit is a first base unit, and wherein the handle comprises a container that is configured to contain at least one of: (i) the first base unit, and (ii) a second base unit.

10. A cutting apparatus, comprising:
a handle having a base unit receiving portion;
a plurality of interchangeable base units configured for selective coupling to the base unit receiving portion, each base unit having a blade configured to cut a medium upon the exertion of a force.

11. An apparatus as recited in claim 10, wherein the blade includes at least one of:
(i) an open-ended blade configuration for creating a notch in the medium; and
(ii) a closed-ended blade configuration for cutting a shape in the medium.

12. An apparatus as recited in claim 10, wherein the handle comprises a metallic shaft.

13. An apparatus as recited in claim 10, wherein the handle comprises a base receiving portion that is configured to receive one of the plurality of interchangeable base units.

14. An apparatus as recited in claim 13, wherein each of the plurality of base units comprises a metallic surface, wherein the base receiving portion comprises a magnet, and wherein the handle and each of the plurality of base units are removably coupled by a magnetic force.

15. An apparatus as recited in claim 10, wherein the handle is interchangeable.

16. An apparatus as recited in claim 10, wherein the handle comprises a metallic shaft that extends down the handle.

17. An apparatus as recited in claim 10, wherein the handle comprises a container that is configured to contain the plurality of base units.

18. A method for creating a notch in a medium, the method comprising:
providing a magnetic notch creating apparatus having a blade with an open-ended configuration;
placing the blade on a precise location of a medium; and
providing a force on the blade to cut a notch in the medium, wherein the notch precisely corresponds to the open-ended blade configuration.

19. A method as recited in claim 18, wherein said providing a magnetic notch creating apparatus having a blade with an open-ended configuration comprises:
selecting one of a plurality of base units; and
magnetically coupling the selected base unit to a base unit receiving portion of the magnetic notch creating apparatus.

20. A method as recited in claim 18, wherein the medium is a first medium, and wherein the notch cut into the first medium is used for at least one of:
coupling a second medium to the first medium without the use of an adhesive;
creating closure options without the use of an adhesive;
creating finger grips in the first medium;
lacing a second medium in relation to the first medium; and
weaving a second medium in relation to the first medium.
